(19) United States
(12) Patent Application Publication
(10) Pub. No.: US 2006/0293888 A1
(43) Pub. Date: Dec. 28, 2006

(54) Providing text during a live voice conversation over a telephone network

(75) Inventor: Dinesh K. Jindal, Naperville, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/168,135

(22) Filed: Jun. 27, 2005

(51) Int. Cl. G10L 15/26

(52) U.S. Cl. 704/235

(57) ABSTRACT

Systems and methods are described for providing text of a voice conversation of a voice call to one or more parties of the voice call. In accordance with one embodiment of the invention, a voice conversion system receives voice traffic from the voice call and converts the voice traffic to text. A buffer system buffers the text, which represents the most recent portion of the voice conversation. Responsive to a request from one of the parties, the buffer system provides the buffered text for display on the party's voice call device (e.g., cell phone). The party may then view and navigate the text of the portion of the voice conversation.

### BACKGROUND OF THE INVENTION

1. Field of the Invention

The invention is related to the field of communications and, in particular, to conversation viewing systems and corresponding methods for providing text during a live voice conversation over a telephone network. More particularly, the invention allows a party to a voice call to request a recent portion of a voice conversation be converted to text and be provided to the requesting person.

2. Statement of the Problem

People frequently use telephone networks on a daily basis at work, at home, and on the road. A calling party places call to a called party over a telephone network, such as a Public Switched Telephone Network or a wireless network. If the called party answers, then the two (or more in a conference call) parties converse. During the voice conversation, any party may miss a word, phrase, or other portion of the conversation. For instance, one party may not hear or understand a word or phrase that another party spoke. That party would then have to ask the other party to repeat the missed portion of the conversation (which may be difficult especially during conference calls, even determining which party had spoken that portion).

One problem with current telephone networks and phones is that they do not provide a mechanism that allows a party to view a portion of a voice conversation that is missed.

### SUMMARY OF THE SOLUTION

The invention solves the above problems and other problems with a network-based or phone-based solution that allows a phone user to view a portion of a voice conversation. In accordance with the invention, the network or the phone is operable to convert an active voice conversation into text and buffer the text. If a phone user misses a portion of the conversation, the phone user may instruct the phone or the network to display that portion of the conversation on the phone. The phone user may be able to scroll through the displayed portion of the conversation to view the portion of the conversation that was missed. The phone user may also perform a search function to search for a particular word or phrase (including searches based on how it sounds—or phonemes). Advantageously, the phone user would not have to ask another party to repeat a missed portion of a conversation, as the phone user could view the text of the conversation.

One embodiment of the invention includes a conversation viewing system comprising a voice conversion system and a buffer system. The conversation viewing system may operate in the voice call device used to place a call, may operate in the telephone network connecting the voice call, or both. In operation, the voice conversion system receives voice traffic from a voice call representing a voice conversation over a telephone network. The voice conversion system converts the voice traffic for the voice conversation to text, and transmits the text of the voice conversation to the buffer system. The buffer system receives and buffers the text of the voice conversation. The buffer system is continually buffering the text of the voice conversation in a first in first out manner so that the text in the buffer system at any time represents the most recent portion of the voice conversation. At some point during the voice call, the buffer system receives a request for a portion of the voice conversation from one of the parties through their voice call device (e.g., a cell phone). Responsive to the request for the portion of the voice conversation, the buffer system provides the text of the portion of the voice conversation for display on the requesting voice call device. The voice call device then displays the text of the portion of the voice conversation for viewing by the party. Once the text of the voice conversation is displayed, the party may scroll through the text or may also use other text-type functions, such as searching for a word, phoneme, or phrase in the text.

In another embodiment of the invention, the buffer system receives voice traffic from the voice call representing a voice conversation between the parties. The buffer system buffers the voice traffic of the voice conversation. The buffer system continually buffers the voice traffic of the voice conversation in a first in first out manner so that the voice traffic in the buffer system at any time represents the most recent portion of the voice conversation. At some point during the voice call, the buffer system receives a request for a portion of the voice conversation from one of the parties through their voice call device. Responsive to the request for the portion of the voice conversation, the buffer system transmits the voice traffic being buffered by the buffer system to the voice conversion system. The voice conversion system converts the voice traffic for the voice conversation to text. The voice conversion system then provides the text of the portion of the voice conversation for display on the requesting voice call device.

The invention may include other exemplary embodiments described below.

### DESCRIPTION OF THE DRAWINGS

The same reference number represents the same element on all drawings.

FIG. 1 illustrates a telephone network connecting a voice call between a first party and a second party.

FIG. 2 illustrates a conversation viewing system in an exemplary embodiment of the invention.

FIG. 3 is a flow chart illustrating a method of operating the conversation viewing system for the embodiment of FIG. 2.

FIG. 4 illustrates a conversation viewing system in another exemplary embodiment of the invention.

FIG. 5 is a flow chart illustrating a method of operating the conversation viewing system for the embodiment of FIG. 4.

FIG. 6 illustrates another telephone network connecting a voice call between a first party and a second party.

FIG. 7 illustrates a phone utilizing a conversation viewing feature in an exemplary embodiment of the invention.

FIG. 8 illustrates one embodiment of a buffer system in an exemplary embodiment of the invention.

### DETAILED DESCRIPTION OF THE INVENTION

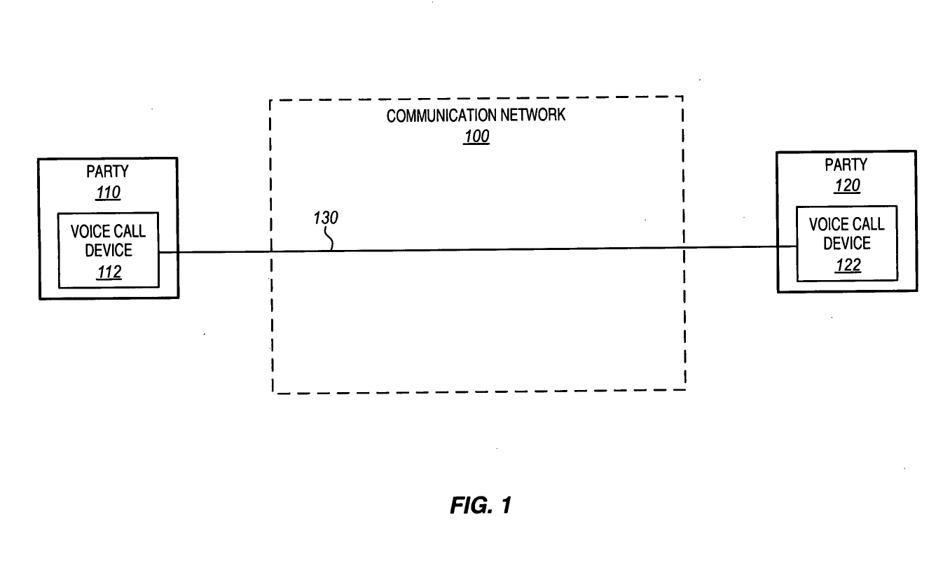

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a telephone network 100 connecting a voice call between a first party 110 and a second party 120. Line 130 through telephone network 100 illustrates the active voice call between party 110 and party 120. Telephone network 100 may comprise a wireless network, a circuit-based network, a packet-based network, or any combination thereof. Party 110 uses voice call device 112 for communicating over telephone network 100. Party 120 uses voice call device 122 for communicating over telephone network 100. Either or both of voice call devices 112 and 122 may comprise a landline phone, a cell phone, a PDA, a BlackBerry, a VoIP phone, etc. Telephone network 100 may include conventional components, devices, or systems not shown in FIG. 1 for the sake of brevity.

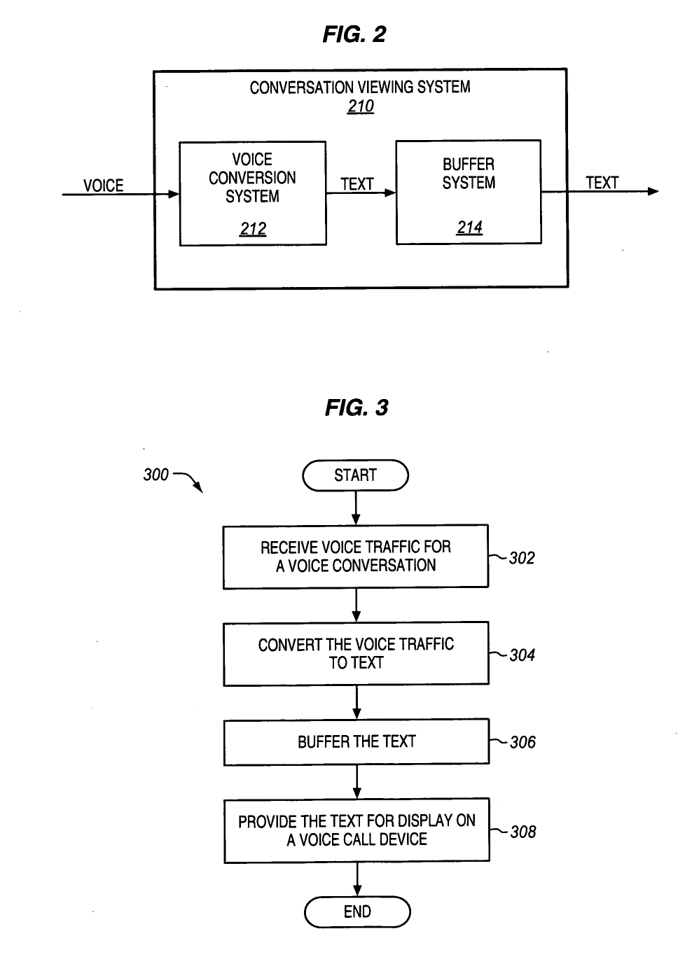

FIG. 2 illustrates a conversation viewing system 210 in an exemplary embodiment of the invention. Conversation viewing system 210 is used in conjunction with telephone network 100 and/or voice call devices 112 and 122 to provide a feature that allows a party 110, 120 to view portions of a voice conversation. In this embodiment, conversation viewing system 210 includes a voice conversion system 212 and a buffer system 214. Voice conversion system 212 comprises any system, device, or component that is operable to convert voice traffic to text. Buffer system 214 comprises any device operable to buffer or temporarily store data or information.

Voice conversion system 212 and buffer system 214 may operate on the same device or system, or may operate on different devices or systems. For instance, voice conversion system 212 and buffer system 214 may both operate in telephone network 100 (see FIG. 1), such as in a switch, a Mobile Switching Center (MSC), an intelligent peripheral, etc, or may both operate in voice call device 112 or 122. Alternatively, voice conversion system 212 may operate in telephone network 100 (see FIG. 1), while buffer system 214 operates in voice call device 112 or 122 (or vice-versa).

One or both of voice conversion system 212 and buffer system 214 may comprise instructions executable by a processing system. Some examples of instructions are software, program code, and firmware. The instructions are operational when executed by the processing system to direct the processing system to operate in accord with the invention. The term “processing system” refers to a single processing device or a group of inter-operational processing devices. Some examples of processors are computers, integrated circuits, and logic circuitry.

FIG. 3 is a flow chart illustrating a method 300 of operating conversation viewing system 210 for the embodiment of FIG. 2. Method 300 may not be all inclusive and may include other steps not shown.

In step 302, voice conversion system 212 receives voice traffic from the voice call representing a voice conversation between party 110 and party 120 over telephone network 100 (see FIG. 1). Voice traffic is defined herein as the analog signals, digital bits, packets, or other information representative of a voice conversation of a voice call. In step 304, voice conversion system 212 converts the voice traffic for the voice conversation to text. Voice conversion system 212 may convert the voice traffic to text in any desired manner. Voice conversion system 212 then transmits the text of the voice conversation to buffer system 214.

In step 306, buffer system 214 receives and buffers the text of the voice conversation. Buffer system 214 has a finite amount of storage space. For instance, buffer system 214 may be able to buffer thirty seconds of voice conversation, one minute of voice conversation, two minutes of voice conversation, etc. Buffer system 214 is continually buffering the text of the voice conversation in a first in first out manner so that the text in the buffer system 214 at any time represents the most recent portion of the voice conversation. To efficiently use the storage space of buffer system 214, buffer system 214 may execute a compression algorithm on the text to compress the text for buffering.

At some point during the voice call, such as when party 110 misses a word or phrase in the voice conversation (see FIG. 1), buffer system 214 receives a request from party 110 to view a portion of the voice conversation. For instance, party 110 may enter a code, such as *9, into voice call device 112 to request to view the portion of the voice conversation and to activate a conversation viewing function. If buffer system 214 is operating on voice call device 112, then buffer system 214 receives the request through internal circuitry in voice call device 112. If buffer system 214 is operating on a node in telephone network 100, then buffer system 214 receives the request from voice call device 112, such as over the signaling channel for the voice call.

In step 308, responsive to the request to view the portion of the voice conversation, buffer system 214 provides the text of the portion of the voice conversation for display on the voice call device 112. If buffer system 214 is operating on voice call device 112, then buffer system 214 transmits the text to a display in voice call device 112 through internal circuitry. If buffer system 214 is operating on a node in telephone network 100, then buffer system 214 transmits the text from the node to the voice call device 112, such as over the signaling channel. The voice call device 112 then displays the text of the portion of the voice conversation for viewing by the party 110. The display may be part of voice call device 112 or may be an external display, such as a caller ID display.

Once the text of the voice conversation is displayed, party 110 may scroll through the text if the text fills more than the screen of voice call device can display. The party 110 may also use other text-type functions, such as searching for a word, phoneme, or phrase in the text.

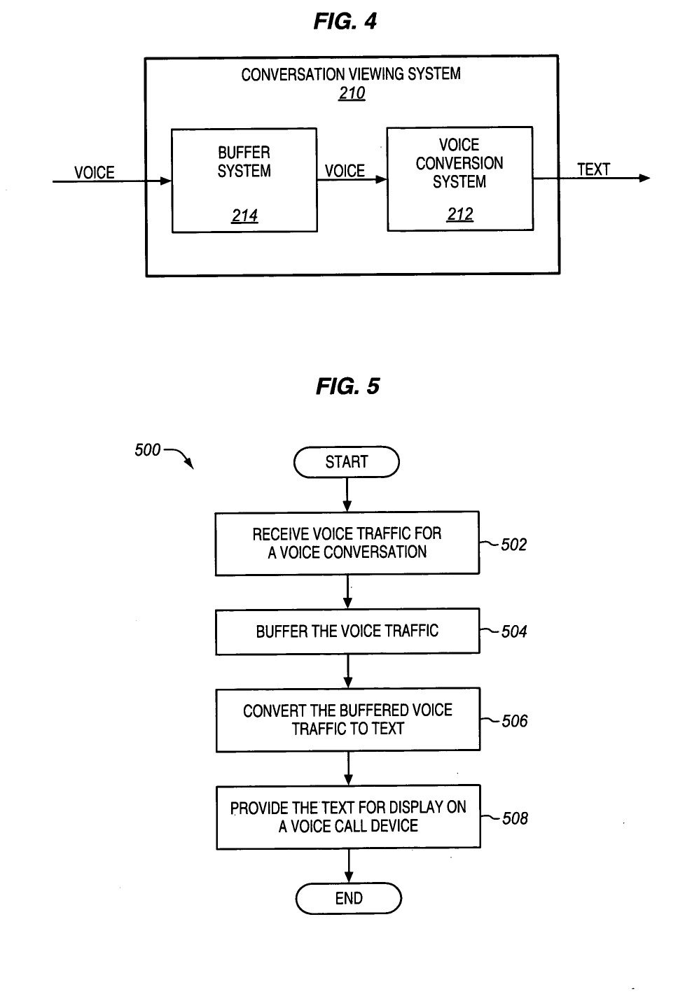

FIG. 4 illustrates another embodiment of the conversation viewing system 210. In this embodiment, conversation viewing system 210 again includes a voice conversion system 212 and a buffer system 214.

FIG. 5 is a flow chart illustrating a method 500 of operating conversation viewing system 210 for the embodiment of FIG. 4. Method 500 may not be all inclusive and may include other steps not shown.

The main difference between the system of FIGS. 2-3 and FIGS. 4-5 is that in the first system the voice is converted to text first and then buffered and there's no need to convert to text on demand, whereas in the second system, the voice is buffered without any conversion and converted to text only on demand.

In step 502, buffer system 214 receives voice traffic from the voice call representing a voice conversation between party 110 and party 120 over telephone network 100 (see FIG. 1). In step 504, buffer system 214 buffers the voice traffic of the voice conversation. Buffer system 214 has a finite amount of storage space. For instance, buffer system 214 may be able to buffer thirty seconds of voice conversation, one minute of voice conversation, two minutes of voice conversation, etc. Buffer system 214 is continually buffering the voice traffic of the voice conversation in a first in first out manner so that the voice traffic in the buffer system 214 at any time represents the most recent portion of the voice conversation.

At some point during the voice call, such as when party 110 misses a word or phrase in the voice conversation (see FIG. 1), buffer system 214 receives a request from party 110 to view a portion of the voice conversation. For instance, party 110 may enter a code, such as *9, into voice call device 112 to request the portion of the voice conversation and to activate a conversation viewing function. If buffer system 214 is operating on voice call device 112, then buffer system 214 receives the request through internal circuitry in voice call device 112. If buffer system 214 is operating on a node in telephone network 100, then buffer system 214 receives the request from voice call device 112, such as over the signaling channel for the voice call.

Responsive to the request for the portion of the voice conversation, buffer system 214 transmits the voice traffic being buffered to voice conversion system 212. The voice traffic being buffered by buffer system 214 comprises the most recent portion of the voice conversation.

In step 506, voice conversion system 212 converts the voice traffic for the voice conversation to text. Voice conversion system 212 may convert the voice traffic to text in any desired manner. In step 508, voice conversion system 212 provides the text of the portion of the voice conversation for display on the voice call device 112. If voice conversion system 212 is operating on voice call device 112, then voice conversion system 212 transmits the text to a display in voice call device 112 through internal circuitry. If voice conversion system 212 is operating on a node in telephone network 100, then voice conversion system 212 transmits the text from the node to the voice call device 112, such as over the signaling channel. The voice call device 112 then displays the text of the portion of the voice conversation for viewing by the party 110. The display may be part of voice call device 112 or may be an external display, such as a caller ID display.

Once the text of the voice conversation is displayed, the party 110 may scroll through the text if the text fills more than the screen of voice call device can display. The party 110 may also use other text-type functions, such as searching for a word or phrase in the text.

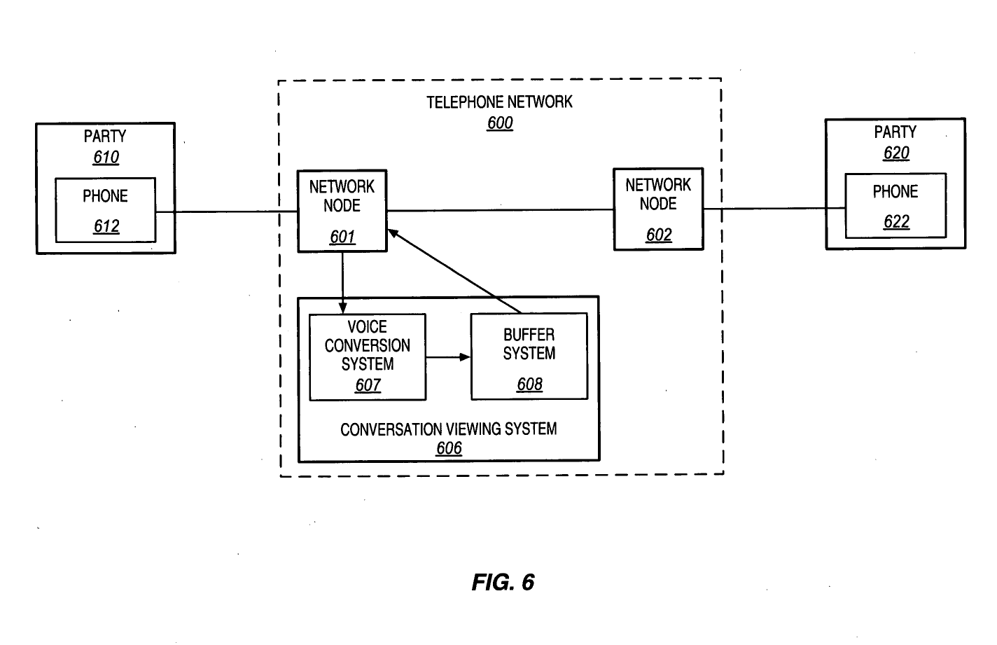

FIG. 6 illustrates another telephone network 600 connecting a voice call between a first party 610 and a second party 620. Telephone network 600 may comprise a wireless network, a circuit-based network, a packet-based network, or any combination thereof. Party 610 uses phone 612 for communicating over telephone network 600. Party 620 uses phone 622 for communicating over telephone network 600. Either or both of phones 612 and 622 may comprise a landline phone, a cell phone, a VoIP phone, etc. Telephone network 600 includes a network node 601 for serving party 610, and a network node 602 for serving party 620. Network nodes 601-602 may comprise switches, MSCs, or another type of network node. Telephone network 600 also includes a conversation viewing system 606 that provides a feature that allows a party 610, 620 to view portions of a voice conversation. Conversation viewing system 606 includes a voice conversion system 607 and a buffer system 608. Telephone network 600 may include conventional components, devices, or systems not shown in FIG. 6 for the sake of brevity.

Assume that party 610 places a call to party 620 over telephone network 600 and party 610 and party 620 begin conversing. During the active voice call between party 610 and party 620, voice conversion system 607 receives voice traffic from the voice call representing the voice conversation between party 610 and party 620. Voice conversion system 607 receives the voice traffic from network node 601 in this embodiment, but may receive the voice traffic from network node 602 or another network node in other embodiments. Voice conversion system 607 converts the voice traffic for the voice conversation to text, and transmits the text to buffer system 608.

Buffer system 608 receives and buffers the text of the voice conversation. Buffer system 608 has a finite amount of storage space. For instance, buffer system 608 may be able to buffer thirty seconds of voice conversation, one minute of voice conversation, two minutes of voice conversation, etc. Buffer system 608 is continually buffering the text of the voice conversation in a first in first out manner so that the text in the buffer system 608 at any time represents the most recent portion of the voice conversation.

For illustration, assume that the conversation includes the following: Party 610: “We should go to a movie tonight. What do you think?”; Party 620: “That sounds good. Let's go to the 7 o'clock movie. We can go to the theater on Broadway. We can try that new restaurant next to the theater after it is over.” Buffer system 608 buffers this portion of the conversation and possibly other portions of the conversation depending on the size of buffer system 608.

At some point during the conversation, party 610 misses the part of the conversation regarding what time they are going to the movie. Instead of asking party 620 to repeat what time, party 610 may activate a conversation viewing function to view text of the most recent portion of the voice conversation.

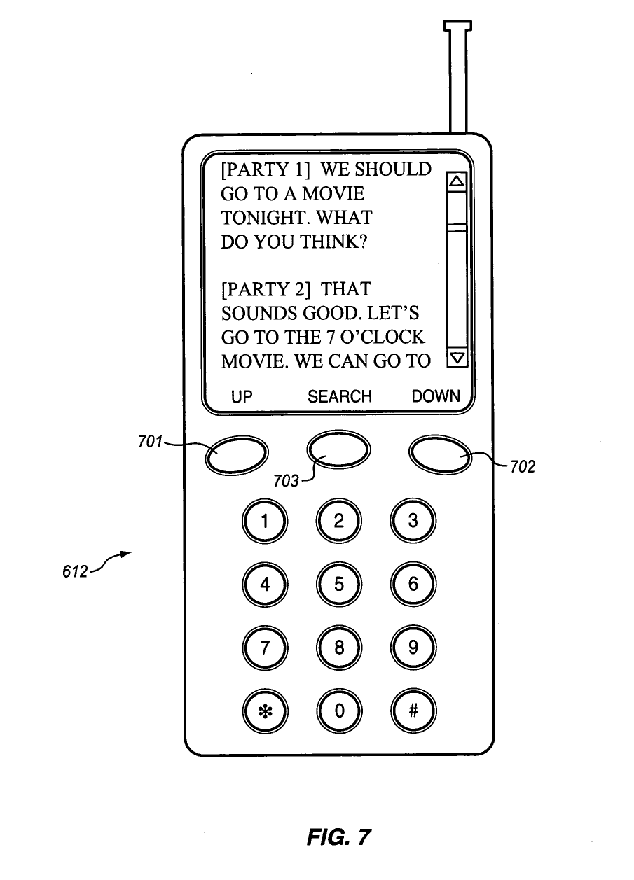

FIG. 7 illustrates phone 612 utilizing a conversation viewing feature in an exemplary embodiment of the invention. To activate the conversation viewing function, party 610 may enter “*9” into the keypad of phone 612 or another code. Responsive to the code entered by party 610, phone 612 transmits a request to view the most recent portion of the voice conversation to network node 601 over a signaling channel between phone 612 and network node 601. Network node 601 then forwards the request to buffer system 608.

Buffer system 608 receives the request from network node 601, and transmits the text of the voice conversation being stored by buffer system 608 to network node 601. Network node 601 transmits the text of the voice conversation to phone 612 over the signaling channel.

Responsive to receiving the text of the voice conversation, phone 612 displays the text to party 610. As is shown in FIG. 7, the most recent portion of the voice conversation is displayed. Party 610 may then view the text and see that party 620 said to meet at “the 7 o'clock movie”. If the portion of the voice conversation is larger than the display of phone 612 (as in FIG. 7), then party 610 may scroll through the text. In this implementation, phone 612 includes two buttons 701-702 that allow party 610 to scroll up and down through the text. Party 610 may alternatively scroll up and down using activation codes such as *1 and *3. Phone 612 also includes a button 703 that allows party 610 to search for a particular word, phoneme, or phrase in the text. Party 610 may alternatively activate the search function by entering an activation code such as *2.

To de-activate the conversation viewing function, party 610 may enter “*8” or another code into the keypad of phone 612. Responsive to the code entered by party 610, phone 612 stops displaying the recent portion of the voice conversation and returns to normal operating mode.

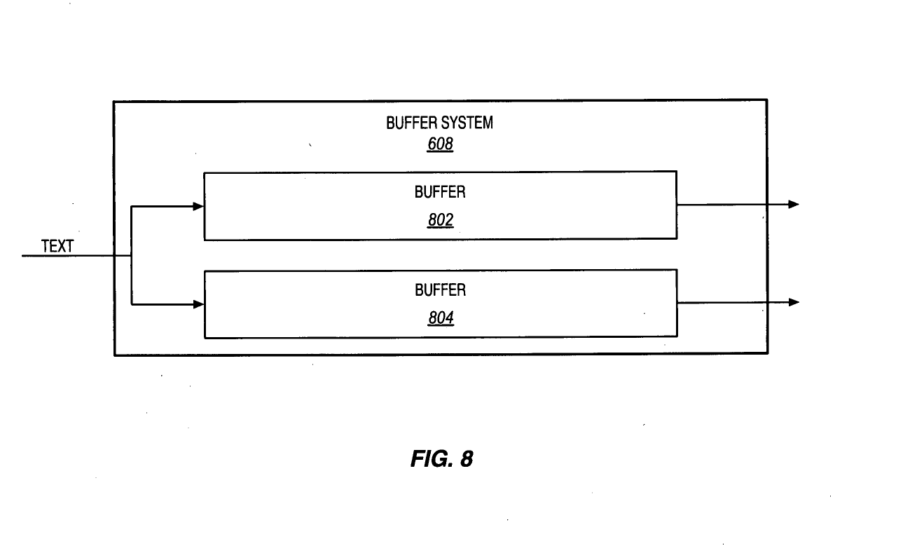

FIG. 8 illustrates one embodiment of buffer system 608 in an exemplary embodiment of the invention. Buffer system 608 includes an active buffer 802 and a standby buffer 804. Buffers are known to those skilled in the art as a temporary storage location for information.

When in operation, buffer system 608 receives text of a voice conversation. Active buffer 802 receives the text and buffers the text. If buffer system 608 receives a request for the most recent portion of a voice conversation, then buffer system 608 copies the active buffer 802 to standby buffer 804. This is done so that standby buffer 804 can continue buffering the text when active buffer 802 is servicing the request. Active buffer 802 then transmits its contents to phone 612 for display to party 610. When the request to display the voice conversation is de-activated, contents of standby buffer 804 are copied back to active buffer 802, and standby buffer 804 is no longer used. In other words, active buffer 802 is the one that is used except during the request. Standby buffer 804 is used to buffer the conversation while active buffer 802 is busy honoring the request. If one wants to request a conversation while displaying the previous conversation, one first de-activates the first request.

Buffer system 608 would operate in a similar manner to buffer voice traffic to the embodiment shown in FIG. 4.

Although specific embodiments were described herein, the scope of the invention is not limited to those specific embodiments. The scope of the invention is defined by the following claims and any equivalents thereof.

I claim:

1. A conversation viewing system, comprising:
a voice conversion system operable to receive voice traffic from a voice call representing a voice conversation between a first party and a second party over a telephone network, and to convert the voice traffic into text; and
a buffer system operable to receive the text from the voice conversion system, buffer the text representing a recent portion of the voice conversation, and to transmit the buffered text for display on a voice call device responsive to receiving a request to view the portion of the voice conversation from the first party or the second party.

2. The conversation viewing system of claim 1 wherein at least one of the voice conversion system and the buffer system is operating in the telephone network.

3. The conversation viewing system of claim 1 wherein at least one of the voice conversion system and the buffer system is operating in the voice call device.

4. The conversation viewing system of claim 1 wherein the buffer system is further operable to execute a compression algorithm to compress the text being buffered.

5. The conversation viewing system of claim 1 wherein the buffer system includes:
an active buffer operable to buffer the text representing the recent portion of the voice conversation, wherein if the request to view the portion of the voice conversation is received, then the active buffer is operable to stop buffering the text, and to provide the text stored in the active buffer for display on the voice call device; and
a standby buffer operable to buffer the text during the request.

6. The conversation viewing system of claim 5 wherein:
upon receiving a request for de-activation, the standby buffer is operable to stop buffering the text; and
the active buffer is operable to again buffer the text.

7. A conversation viewing system, comprising:
a voice conversion system; and
a buffer system operable to receive voice traffic from a voice call representing a voice conversation between a first party and a second party over a telephone network, to buffer the voice traffic representing a recent portion of the voice conversation, and to transmit the buffered voice traffic to the voice conversion system responsive to receiving a request to view the portion of the voice conversation from the first party or the second party;
wherein the voice conversion system is operable to convert the buffered voice traffic into text, and to provide the text for display on a voice call device.

8. The conversation viewing system of claim 7 wherein at least one of the voice conversion system and the buffer system is operating in the telephone network.

9. The conversation viewing system of claim 7 wherein at least one of the voice conversion system and the buffer system is operating in the voice call device.

10. The conversation viewing system of claim 7 wherein the buffer system includes:
an active buffer operable to buffer the text representing the recent portion of the voice conversation, wherein if the request to view the portion of the voice conversation is received, then the active buffer is operable to stop buffering the text, and to provide the text stored in the active buffer for display on the voice call device; and
a standby buffer operable to buffer the text during the request.

11. The conversation viewing system of claim 10 wherein:
upon receiving a request for de-activation, the standby buffer is operable to stop buffering the text; and
the active buffer is operable to again buffer the text.

12. A method of allowing a party to view a portion of a voice conversation of a voice call placed over a telephone network, the method comprising:
receiving voice traffic from a voice call representing a voice conversation between a first party and a second party over the telephone network;
converting the voice traffic into text;
buffering the text representing a recent portion of the voice conversation; and
providing the buffered text for display on a voice call device responsive to receiving a request to view the portion of the voice conversation from the first party or the second party.

13. The method of claim 12 further comprising:
providing a scrolling mechanism on the voice call device that allows for scrolling through the text representing the recent portion of the voice conversation.

14. The method of claim 12 further comprising:
providing a search mechanism on the voice call device that allows for searching for a word or phrase in the text representing the recent portion of the voice conversation.

15. The method of claim 12 wherein at least one of the steps of the method are performed in the telephone network.

16. The method of claim 12 wherein at least one of the steps of the method are performed in the voice call device.

17. The method of claim 12 further comprising:
executing a compression algorithm to compress the text being buffered.

18. The method of claim 12 further comprising:
displaying the text on the voice call device.

19. The method of claim 12 further comprising:
displaying the text on a caller ID device.
